(19) United States
(12) Patent Application Publication
(10) Pub. No.: US 2026/0225283 A1
(43) Pub. Date: Aug. 6, 2026

(54) HIGHLY-INSULATED INGOT MOLD

(71) Applicant: HarbisonWalker International Holdings, Inc., Pittsburgh, PA (US)

(72) Inventor: Donald ABRINO, Curwensville, PA (US)

(73) Assignee: HarbisonWalker International Holdings, Inc., Pittsburgh, PA (US)

(21) Appl. No.: 19/634,300

(22) Filed: Mar. 31, 2026

Related U.S. Application Data
(63) Continuation-in-part of application No. 17/895,268, filed on Aug. 25, 2022, now Pat. No. 12,611,795.
(60) Provisional application No. 63/237,633, filed on Aug. 27, 2021.

(51) Int. Cl. B28B 7/36; C04B 35/653

(52) U.S. Cl. CPC B28B 7/36; C04B 35/653

(57) ABSTRACT

An ingot mold for curing fused and melted material is provided. The ingot mold includes a steel box, an insulation material layer lining an inner surface of the steel box, a foamed carbon layer formed inward of the insulation material layer, and a graphite block layer formed inward of the foamed carbon layer and positioned to contact the fused and melted material. The insulation material layer includes a non-oxide based insulation material having a service temperature of at least about 3000°F. A combined thermal resistance of the insulation material layer and the foamed carbon layer is greater than a thermal resistance of the graphite block layer.

### RELATED APPLICATIONS

This application is a Continuation-in-Part of U.S. Patent Application No. 17/895,268, filed on August 25, 2022, which claims the benefit of U.S. Provisional Patent Application No. 63/237,633, filed August 27, 2021, the above-referenced documents hereby fully incorporated herein by reference.

### FIELD OF THE INVENTION

The present invention relates generally to the use of ingot molds to manufacture ingots or fused cast shapes of electro-fused material, and, more particularly, to providing an ingot mold with the ability to produce an ingot or fused cast shape of electro-fused material which, being highly insulated, cools slowly and has an increased crystal size and greater uniformity.

### BACKGROUND OF THE INVENTION

The manufacturing of many electro-fused materials and electro-fused shapes requires a slow cool down to obtain proper crystal size and properties, especially when making such electro-fused materials through the forming of either a fused cast shape or an ingot intended to be later crushed and sized to achieve desired synthetic fused grain.

For example, when manufacturing fused magnesia (MgO) for conversion into high-quality fused MgO grain to be used in refractory products, the crystal size of the fused MgO grain is important. A Higgins furnace design, as shown in the furnace 2 illustrated in FIG. 1, is most often used to achieve this fusion process. This type of furnace 2 uses a large, water-cooled ingot chamber 4. To maintain a required melting temperature in the ingot chamber 4, only the center 6 of the ingot is melted by graphite electrodes 12 that are powered through an AC transformer 13. The materials being fused in the ingot chamber 4 insulate the melted center 6 of the ingot from the outside wall 8 of the ingot chamber 4. This insulation is only partially adequate and, as a result, the fused MgO develops a proper crystal size only in the center 6 of the ingot chamber 4.

The furnace 2 and furnaces designed in this manner are very inefficient. Once the MgO in the ingot is fused, the graphite electrodes 12 are removed from the furnace 2, and the ingot chamber 4 is moved away from the furnace 2, thereby allowing the MgO ingot to cool. This cooling process normally takes between one and three days. After cool down is complete, the resultant MgO ingot is removed from the chamber 4. The outer portion of the ingot 10 that is unfused and has not been melted is then removed and separated from the electro-fused center 6 of the ingot. Only the center 6 of the ingot is suitable for the fused MgO grain product. The removed outer portion of the ingot 10, which is often more than 40% of the total ingot weight, is either disposed of or recycled back to the furnace 2. Thus, the yield of fused MgO grain from the ingot mold chamber 4 of the Higgins furnace 2 is often less than 60%. In addition, a sufficient amount of labor and cost is required just to remove the outer portion 10, thereby making the Higgins furnace 2 design even more inefficient.

FIG. 2 illustrates a conventional tilt furnace 14 and a standard practice steel and graphite ingot mold 16 into which material 18 that has been melted and fused in the tilt furnace 14 is poured. Within the standard practice ingot mold 16, the melted and fused material 18 is cured into an ingot or a fused cast shape. The tilt furnace 14 can be used as an alternative to the Higgins furnace 2. A source material of MgO or another material is charged to the tilt furnace 14 through the charging door 26. Similar to the process of the Higgins furnace 2, the center of the material to be the fused and melted material 18 is melted by graphite electrodes 28 that are powered through an AC transformer 15. The resultant fused and melted material 18 is poured out of the furnace 14 through a pour spout in the furnace 24 into the standard practice ingot mold 16, while the non-melted material 30 remains in the tilt furnace 14.

The standard practice ingot mold 16, which is illustrated schematically in FIG. 3 when empty, is typically a water-cooled or air-cooled steel box 20 lined with about two inches of dense graphite block 22 on the bottom and side walls of the box 20. Fused and melted material 18 will reside in the mold long enough to freeze the surface due to the high heat loss through the highly heat conductive steel and graphite materials. As a result, an ingot or a fused cast shape is produced. Water cooling enhances this process, although air cooling or additional residence time in the mold can be utilized if crystal size is not important. Regardless, after the surface of the fused and melted material 18 is frozen, the resultant ingot or fused cast shape may be removed from the standard practice ingot mold 16 while still white hot and moved to a designated cooling area or a secondary heating furnace.

However, while this is a much more efficient process with less waste that is the process utilizing the Higgins furnace 2, the process still results in a cooling of the fused and melted material 18 that is undesirably rapid. The standard practice ingot mold 16 is effectively a non-insulated design that relies on rapid cooling to ensure the integrity of the steel box 20, thereby resulting in an ingot or a fused cast shape with crystals of a very small size.

A double lined graphite ingot mold 32, as is illustrated when empty in FIG. 4, can be utilized to decrease the heat flux causing the rapid cooling. Such an ingot mold 32 includes a water-cooled steel box 38 lined with a first two-inch dense graphite block 34. The first two-inch dense graphite block 34 is then lined with a second two-inch dense graphite block 36. The result of this doubling of graphite block thickness reduces the heat flux, but not to an extent of having a dramatic impact on the increase in crystal size of the ingot or the fused cast shape.

Occasionally, the tilt furnace 14 has been used in conjunction with large, heated holding furnaces or highly insulated holding furnaces for holding hot ingots or fused cast shapes with solidified outer surfaces that have been removed from the ingot mold while still having a liquid center, thereby slowing down the cooling in order to at least obtain larger crystals in the center of the ingot or the fused cast shapes. However, this process is costly and not universally suitable for all materials. As such, processes utilizing tilt furnaces 14 are not suitable when large fused material crystals or large fused MgO crystals are required to be produced.

### SUMMARY OF THE INVENTION

According to an aspect of the invention, an ingot mold for curing fused and melted material is provided. The ingot mold includes a steel box, an insulation material layer lining an inner surface of the steel box, a foamed carbon layer formed inward of the insulation material layer, and a graphite block layer formed inward of the foamed carbon layer and positioned to contact the fused and melted material. The insulation material layer includes a non-oxide based insulation material having a service temperature of at least about 3000°F. A combined thermal resistance of the insulation material layer and the foamed carbon layer is greater than a thermal resistance of the graphite block layer.

According to an embodiment, the non-oxide based insulation material has a service temperature of at least about 3300°F.

According to an embodiment, the non-oxide based insulation material has a service temperature of at least about 3500°F.

According to an embodiment, the non-oxide based insulation material has a thermal conductivity less than about 10 W/m·K at temperatures of about 3600°F or greater.

According to an embodiment, the non-oxide based insulation material has a porosity greater than about 40%.

According to an embodiment, the non-oxide based insulation material is selected from the group consisting of carbon-based materials, carbide-based materials, nitride-based materials, and combinations thereof.

According to an embodiment, the non-oxide based insulation material is selected from the group consisting of graphite foams, carbon foams, carbon aerogels, carbon felt, carbon fiber mats, silicon carbide foams, porous boron carbide, silicon nitride, aluminum nitride, hexagonal boron nitride, and combinations thereof.

According to an embodiment, the insulation material layer has a thickness from about 0.5 inches to about 6 inches.

According to an embodiment, the foamed carbon layer has a thickness from about 0.5 inches to about 18 inches.

According to an embodiment, the graphite block layer has a thickness from about 0.5 inches to about 6 inches.

According to an embodiment, the non-oxide based insulation material comprises a first foamed carbon layer and the foamed carbon layer formed inward thereof comprises a second foamed carbon layer.

According to an embodiment, the first and second foamed carbon layers differ in density, porosity, or thermal conductivity.

According to an embodiment, the ingot mold further includes a lid. The lid includes a steel frame, a lid insulation material layer lining an inner surface of the steel frame, a lid foamed carbon layer formed inward of the lid insulation material layer, and a lid graphite block layer formed inward of the lid foamed carbon layer.

According to another aspect of the invention, an ingot mold for curing fused and melted material is provided. The ingot mold includes a steel box, a non-oxide based insulation material layer, a foamed carbon layer, and a graphite block layer positioned to contact the fused and melted material. The ingot mold reduces heat flux to less than about 25% of a heat flux of a standard practice ingot mold lined solely with dense graphite blocks.

According to an embodiment, the ingot mold reduces heat flux to less than about 15% of the standard practice ingot mold.

According to an embodiment, the ingot mold reduces heat flux to less than about 10% of the standard practice ingot mold.

According to an embodiment, the fused and melted material cast into the mold remains within a crystal growth temperature range for at least about 12 hours following casting.

According to another aspect of the invention, a method of producing a fused cast ingot having increased crystal size is provided. The method includes pouring fused and melted material into an ingot mold and allowing the material to cool within the ingot mold. The ingot mold includes a steel box, a non-oxide based insulation material layer, a foamed carbon layer, and a graphite block layer. The material remains within a crystal growth temperature range for at least about 12 hours following casting.

According to an embodiment, the material remains within the crystal growth temperature range for between about 18 hours and about 36 hours.

According to an embodiment, the fused and melted material is selected from the group consisting of MgO, alpha alumina, beta alumina, calcia, chromia, silica, zirconia, silicon carbide, and combinations thereof.

According to another aspect of the invention, an ingot mold for curing fused and melted material is provided. The ingot mold includes a steel box, a non-oxide based insulation material layer lining an inner surface of the steel box, a foamed carbon layer formed inward of the insulation material layer, and a graphite block layer formed inward of the foamed carbon layer and positioned to contact the fused and melted material. The non-oxide based insulation material has a service temperature of at least about 3000°F. A combined thermal resistance of the insulation material layer and the foamed carbon layer is greater than a thermal resistance of the graphite block layer. The ingot mold reduces heat flux to less than about 25% of a heat flux of a standard practice ingot mold lined solely with dense graphite blocks.

According to an embodiment, the fused and melted material cast into the mold remains within a crystal growth temperature range for at least about 12 hours following casting.

An advantage of certain embodiments defined herein is reduced conductive heat transfer through the mold wall. As a result, cooling of the fused and melted material may be slowed relative to conventional graphite-lined molds.

An advantage of certain embodiments defined herein is maintenance of the fused and melted material within a crystal growth temperature range for an extended period following casting. As a result, increased crystal size and improved microstructural uniformity may be achieved.

An advantage of certain embodiments defined herein is the use of non-oxide based insulation materials having high temperature stability. As a result, insulating performance may be maintained at interface temperatures that can degrade certain oxide-based insulation materials.

An advantage of certain embodiments defined herein is reduction of thermal gradients within the cast material during cooling. As a result, casting defects associated with rapid solidification may be reduced.

An advantage of certain embodiments defined herein is extended crystallization time without reliance on large ingot chamber furnaces or secondary holding furnaces. As a result, production efficiency and yield may be improved.

These and other advantages will become apparent from the following detailed description of the invention taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a schematic illustration of an example conventional Higgins furnace;

FIG. 2 is a schematic illustration of an example conventional tilt furnace and an example ingot mold into which ingot or cast material that is melted and fused in the tilt furnace is poured;

FIG. 3 is a schematic illustration of an example conventional ingot mold lined with a single block of dense graphite;

FIG. 4 is a schematic illustration of an example conventional ingot mold lined with two blocks of dense graphite;

FIG. 5 is a schematic illustration of an example ingot mold according to an embodiment of the invention;

FIG. 6 is a schematic illustration of an example ingot mold according to another embodiment of the invention;

FIG. 7 is a schematic illustration of an example ingot mold according to an additional embodiment of the invention; and

FIG. 8 is a graphical illustration showing the relative heat flux of the ingot molds illustrated in FIGS. 3-7.

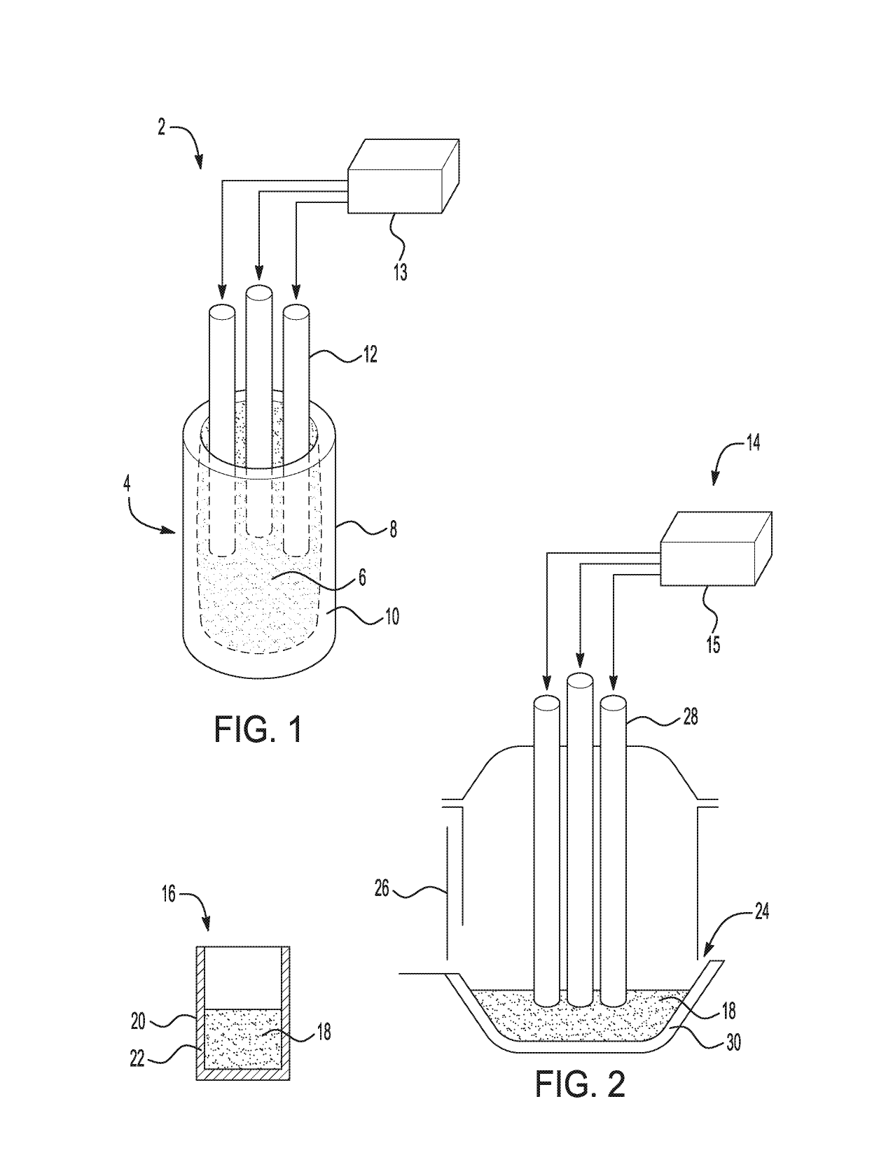

### DETAILED DESCRIPTION OF THE INVENTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. In addition, descriptions of functions and constructions that are well known to one of ordinary skill in the art may be omitted for increased clarity and conciseness. The drawings may not be to scale, and the relative size, proportions, and depiction of elements in the drawings may be exaggerated for clarity, illustration, and convenience.

Foamed carbon has a unique set of properties, including, but not limited to, a high resistance to temperature complemented with a very low thermal conductivity. This enables the pouring of fused and melted material, such as MgO, into a foamed carbon containing ingot mold from a spout of a conventional tilt furnace, such as the tilt furnace 14 that was illustrated in FIG. 2. The foamed carbon enhances the ingot mold with a very low thermal conductivity while simultaneously withstanding the high temperatures of the fused and melted material, the ingot, or the fused cast shape in the ingot mold. This will enable the temperature of the fused and melted material, the ingot, or the fused cast shape to be held for increased periods, thereby allowing for the formation of large crystals.

Foamed carbon can be applied either as a surface layer of an ingot mold in contact with the fused and melted material, the ingot, or the fused cast shape, or as a back-up layer, i.e. insulation layer, of an ingot mold that backs up a surface layer in contact with the fused and melted material, the ingot, or the fused cast shape. The surface layer may be a graphite surface layer or a surface layer formed from another suitable material. One layer may be directly lined on an inner surface of another layer. One layer may line an entirety of an inner surface of another layer.

Most common constructions can be used to configure the various embodiments of the ingot mold including the foamed carbon. The heavy frame of the water-cooled or air-cooled steel box 20 serves to hold the graphite block 22 in place for the bottom and the sidewalls of the standard practice ingot mold 16. The ingot mold including the foamed carbon has an increased overall thickness due to the inclusion of multiple insulation layers. Ideally, whether being used as the surface layer or the back-up layer of an ingot mold, the sizing of a foamed carbon component should accommodate one full heat, i.e. ingot creation, while still allowing the top of an ingot mold to be constructed with a steel frame.

A lid corresponding with the construction of the ingot mold can be placed on top of the ingot mold by machinery as soon as the pouring of the fused and melted material into the ingot mold is complete. Examples of such a lid will be described in further detail in the discussion below with respect to inventive embodiments.

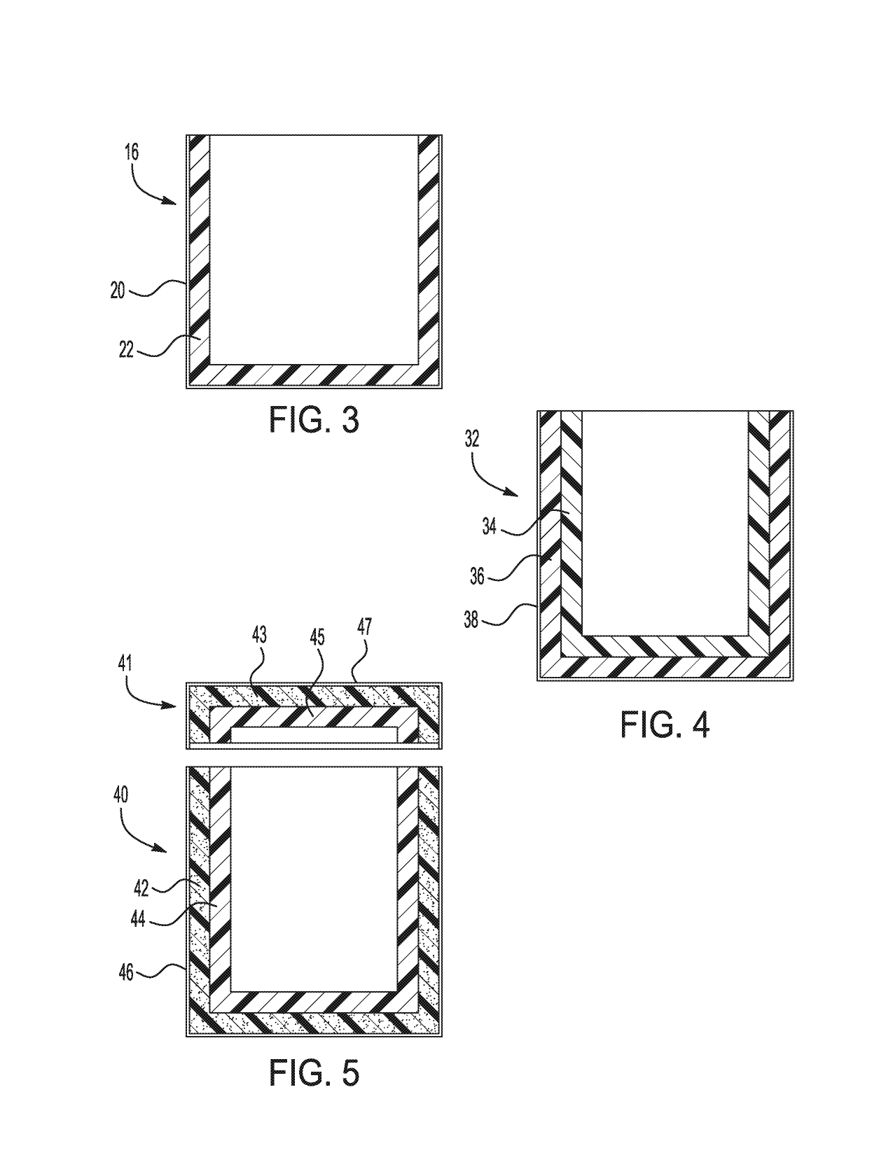

To understand the thermal consequences related to the incorporation of foamed carbon in an ingot mold, FIG. 8 shows the relative heat flux of various example mold designs with and without foamed carbon or other oxide-based insulations. “100 %” is reflected as being the heat flux of the standard practice ingot mold 16 illustrated in FIG. 3 that is used with a conventional furnace or a tilt furnace having a spout, such as the tilt furnace 14 illustrated in FIG. 2.

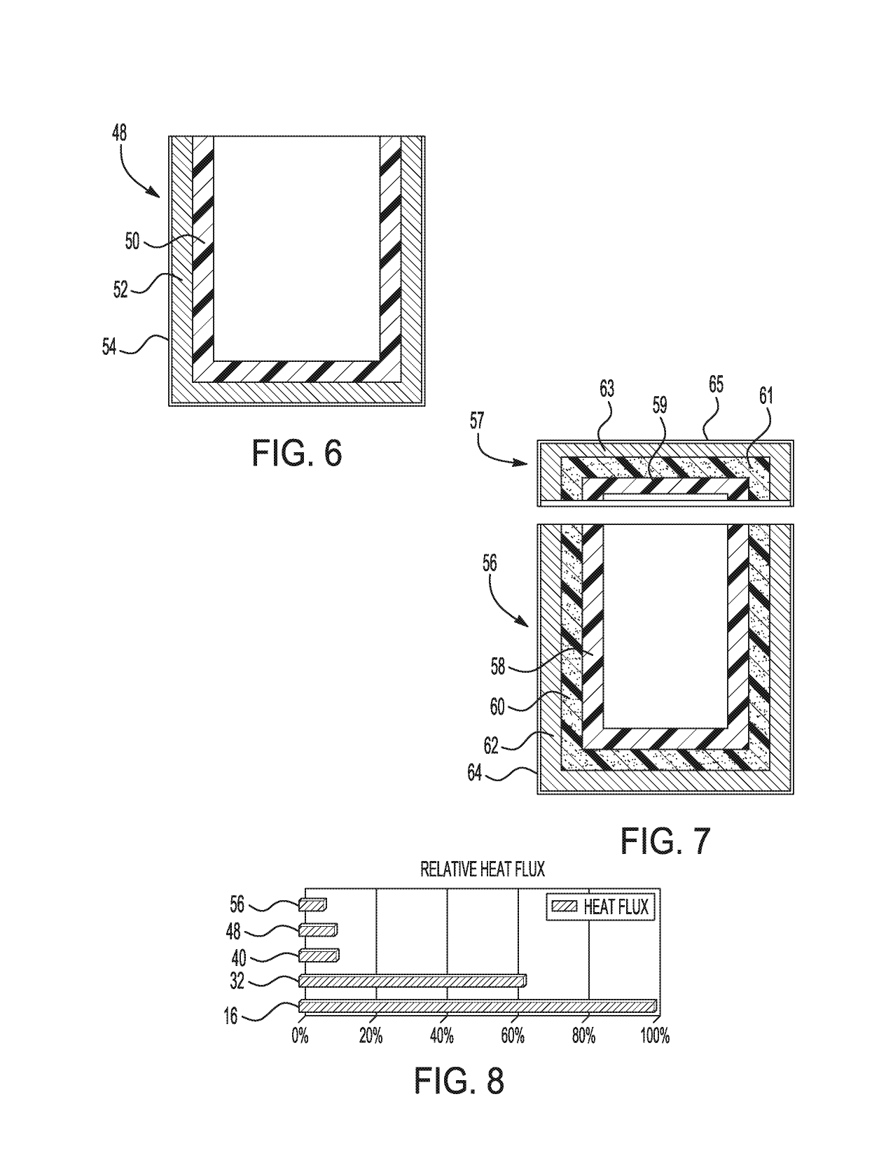

More specifically, while the invention is not limited to these examples, FIG. 8 illustrates the relative heat flux between the standard practice ingot mold 16 illustrated in FIG. 3, the double lined graphite ingot mold 32 illustrated in FIG. 4, the graphite and foamed carbon lined ingot mold 40 illustrated in FIG. 5, the graphite and bubble alumina lined ingot mold 48 of FIG. 6, and the graphite, foamed carbon, and bubble alumina lined ingot mold 56 of FIG. 7.

As used herein, a “standard practice ingot mold” refers to an ingot mold comprising a water-cooled or air-cooled steel box lined solely with dense graphite blocks along the bottom and sidewalls and lacking additional insulating layers positioned between the steel box and the graphite blocks. In certain embodiments, the standard practice ingot mold corresponds to the configuration illustrated in FIG. 3. Minor variations in graphite block thickness, steel box dimensions, or cooling configuration do not depart from the meaning of a standard practice ingot mold provided that no additional oxide-based or non-oxide based insulation layers are present between the steel box and the graphite blocks.

For purposes of relative heat flux comparison, the standard practice ingot mold is assumed to include dense graphite blocks having a thickness of approximately two inches lining the bottom and sidewalls of the steel box, consistent with conventional commercial practice as described above with respect to FIG. 3. Relative heat flux comparisons are conducted under comparable casting conditions, including substantially similar mold geometry, casting volume, cooling configuration, and environmental conditions. Variations in graphite thickness, steel box dimensions, or cooling method that do not introduce additional insulating layers do not materially alter the classification of a mold as a standard practice ingot mold for purposes of percentage-based heat flux comparison.

As used herein, “heat flux” refers to the rate of thermal energy transfer per unit area through the wall structure of the ingot mold during cooling of fused and melted material. Heat flux may be determined through direct measurement using embedded thermocouples and temperature gradient analysis, calorimetric techniques, or through validated thermal modeling based on known material thermal conductivities, layer thicknesses, and boundary conditions. In certain embodiments, relative heat flux is determined under comparable casting conditions, including similar mold geometry, casting volume, and environmental conditions. When expressed as a percentage relative to a standard practice ingot mold, heat flux refers to the steady-state or time-averaged conductive heat transfer through the mold wall during the primary cooling phase following casting.

As used herein, “thermal resistance” refers to the resistance to conductive heat transfer through a material layer and may be expressed as a function of layer thickness divided by thermal conductivity. For a multilayer wall structure, total thermal resistance may be determined as the sum of the individual thermal resistances of each layer under comparable boundary conditions. In certain embodiments, relative thermal resistance comparisons are based upon known or measured thermal conductivities and actual layer thicknesses of the respective materials forming the mold wall structure.

As used herein, “crystal growth temperature range” refers to a temperature range in which crystal coarsening, grain growth, or microstructural development of the fused and melted material occurs following casting. The crystal growth temperature range may vary depending on the specific composition of the fused material, but generally corresponds to temperatures below the fully molten state and above temperatures at which diffusion-driven crystal growth substantially ceases. In certain embodiments, the crystal growth temperature range encompasses temperatures at which solidification has occurred but sufficient atomic mobility remains to permit continued crystal enlargement and microstructural homogenization.

The deficiencies in the standard practice ingot mold 16 illustrated in FIG. 3 and the double lined graphite ingot mold 32 illustrated in FIG. 4 have already been discussed above in the “Background of the Invention”. In comparison, the graphite and foamed carbon lined ingot mold 40 illustrated in FIG. 5 is a water-cooled or air-cooled steel box 46 lined with anywhere from one to twelve inches of a layer of foamed graphite 42, i.e. foamed carbon, on an inner surface thereof. A two-inch dense graphite block 44 is then lined over the foamed carbon layer 42.

A lid 41 corresponding with the construction of the graphite and foamed carbon lined ingot mold 40 is placed on top of the graphite and foamed carbon lined ingot mold 40 by machinery as soon as the pouring of the fused and melted material into the graphite and foamed carbon lined ingot mold 40 is complete. The graphite and foamed carbon lined ingot mold lid 41 is a steel frame 47 corresponding with the water-cooled or air-cooled steel box 46. The steel frame 47 is lined with anywhere from one to twelve inches of foamed graphite 43, i.e. foamed carbon, on an inner surface thereof that corresponds with the layer of foamed carbon 42 of the graphite and foamed carbon lined ingot mold 40. A two-inch dense graphite block 45 corresponding with the two-inch dense graphite block 44 of the graphite and foamed carbon lined ingot mold 40 is then lined over the foamed carbon components 60 of the graphite, foamed carbon, and bubble alumina lined ingot mold 56.

The layer of foamed carbon 42 serves to insulate the fused and melted material, the ingot, or the fused cast shape deposited in the graphite and foamed carbon lined ingot mold 40. As such, the thickness of the layer of foamed carbon 42 provided serves to determine the heat flux of the graphite and foamed carbon lined ingot mold 40. Further, the size of the graphite and foamed carbon lined ingot mold 40 and the amount of the fused and melted material deposited therein will affect the thickness of the layer of foamed carbon 42 necessary to maintain the heat flux of the graphite and foamed carbon lined ingot mold 40 at a predetermined amount.

As is shown in FIG. 8, the relative heat flux of the graphite and foamed carbon lined ingot mold 40 illustrated in FIG. 5 is only 10% of the relative heat flux that occurs in the standard practice ingot mold 16. In other words, if all sides of an ingot mold (including the lid) are constructed in accordance with the graphite and foamed carbon lined ingot mold 40, the fused and melted material, the ingot, or fused cast shape deposited in the graphite and foamed carbon lined ingot mold 40 will roughly take nine times longer to cool than fused and melted ingot material or fused cast shape deposited in the standard practice ingot mold 40, thereby serving to have a dramatically increased crystal size from that which is cooled in the standard practice ingot mold 16.

In addition, the standard practice ingot mold 16 is assumed to be within the temperature suitable for crystal growth only for two to four hours after the fused and melted material 18 is poured from the tilt furnace 14 into the standard practice ingot mold 16 for casting. On the other hand, fused and melted material 18 poured from the tilt furnace 14 into the graphite and foamed carbon lined ingot mold 40 will be within the temperature suitable for crystal growth for 18 to 36 hours after casting. This extended crystallization period is also important in production of high quality fused-cast shapes with a reduced frequency of casting defects. This length of cooling afforded by the graphite and foamed carbon lined ingot mold 40 is similar, if not longer, to that which is afforded by the ingot chamber 4 of the Higgins furnace 2. An ingot shape formed in the Higgins furnace 2, which includes the fused and melted ingot or fused cast shape material 6 surrounded and insulated in the ingot chamber 4 by the outer portion of the ingot 10 that is unfused and has not been melted, is typically removed from the ingot chamber 4 in 24 hours. At that time, the temperature of the fused and melted ingot or fused cast shape material 6 is lower than a temperature necessary to grow crystals.

When used as insulation backing behind the graphite block layer 44, the foamed carbon 42 has a temperature resistance that is greater than any conventional oxide-type insulation backing. Even bubble alumina, which is considered to be the most temperature-resistant oxide-based insulation, is only resistive up to 3300 °F, which is not high enough to be used behind four inches of graphite block.

For example, the graphite and bubble alumina lined ingot mold 48 illustrated in FIG. 6 is a water-cooled or air-cooled steel box 54 lined with 2.5 inches of bubble alumina 52 on an inner surface thereof. The 2.5-inch bubble alumina layer 52 is then lined with a four-inch dense graphite block 50.

While the graphite and bubble alumina lined ingot mold 48 illustrated in FIG. 6 is indicated in FIG. 8 as having a relative heat flux corresponding with that of the graphite and foamed carbon lined ingot mold 40 illustrated in FIG. 5, the temperature at the interface between the graphite block 50 and bubble alumina layer 52 would exceed 3300 °F temperature, which is the service limit of bubble alumina material. This will result in an early failure of the bubble alumina layer 52, thereby leading to a greater relative heat flux than is shown.

However, if foamed carbon is incorporated as a middle layer between graphite block and oxide-based insulation materials, such as bubble alumina, properties possessed by the foamed carbon will enable oxide-based insulation materials to be used as a lining for the steel box of an ingot mold.

For example, the graphite, foamed carbon, and bubble alumina lined ingot mold 56 of FIG. 7 is a water-cooled or air-cooled steel box 64 lined with 2.5 inches of an oxide-based bubble alumina outer insulating layer 62 on an inner surface thereof. The 2.5-inches of bubble alumina 62 is then lined with anywhere from one to twelve inches of foamed carbon components 60. The foamed carbon components 60 are lined with two inches of graphite block 58.

A lid 57 corresponding with the construction of the graphite, foamed carbon, and bubble alumina lined ingot mold 56 is placed on top of the graphite, foamed carbon, and bubble alumina lined ingot mold 56 by machinery as soon as the pouring of the fused and melted material into the graphite, foamed carbon, and bubble alumina lined ingot mold 56 is complete. The graphite, foamed carbon, and bubble alumina lined ingot mold lid 57 is a steel frame 65 corresponding with the water-cooled or air-cooled steel box 64. The steel frame 65 is lined with 2.5 inches of an oxide-based bubble alumina outer insulating layer 63 on an inner surface thereof that corresponds with the 2.5 inches of the oxide-based bubble alumina outer insulating layer 62 lined on the inner surface of the water-cooled or air-cooled steel box 64 of the graphite, foamed carbon, and bubble alumina lined ingot mold 56. The 2.5-inches of bubble alumina 63 of the lid 57 is lined with anywhere from one to twelve inches of foamed carbon components 61 on an inner surface thereof that corresponds with the foamed carbon components 60 of the graphite, foamed carbon, and bubble alumina lined ingot mold 56. A two-inch dense graphite block 59 corresponding with the two-inch dense graphite block 58 of the graphite, foamed carbon, and bubble alumina lined ingot mold 56 is then lined over the foamed carbon layer 43 of the graphite and foamed carbon lined ingot mold lid 41.

As is the case with the foamed carbon layer 42 illustrated in FIG. 5, the foamed carbon components 60 illustrated in FIG. 7 serve to insulate the fused and melted material, the ingot, or the fused cast shape deposited in the graphite, foamed carbon, and bubble alumina lined ingot mold 56. As such, the thickness of the layer of foamed carbon components 60 provided serves to determine the heat flux of the graphite, foamed carbon, and bubble alumina lined ingot mold 56. Further, the size of the graphite, foamed carbon, and bubble alumina lined ingot mold 56 and the amount of the fused and melted material deposited therein will affect the thickness of the layer of foamed carbon components 60 necessary to maintain the heat flux of the graphite, foamed carbon, and bubble alumina lined ingot mold 56 at a predetermined amount.

As is illustrated in FIG. 8, the graphite, foamed carbon, and bubble alumina lined ingot mold 56 is 7 % of that of the standard practice ingot mold 16. Further, since the bubble alumina layer 62 is insulated by the graphite block layer 58 and the foamed carbon layer 60, the temperature at the interface between the foamed carbon layer 60 and the bubble alumina layer 62 is less than 3300 °F and, therefore, within the temperature service limit.

Moreover, it would be understood that, in the graphite, foamed carbon, and bubble alumina lined ingot mold 56 of FIG. 7, due to the positioning of the foamed carbon layer 60, the bubble alumina layer 62 could be replaced by layers of standard technology insulations or other oxide-based insulation materials, thereby yielding even greater reductions in temperature.

In addition to oxide-based insulation materials, it is further contemplated that the outer insulating layer lining the steel box may include a non-oxide based insulation material. As used herein, a “non-oxide based insulation material” refers to a thermally insulating material whose primary chemical composition does not consist of metal oxides and which is capable of withstanding temperatures of at least about 3000°F without structural degradation sufficient to impair its insulating function.

In certain embodiments, the non-oxide based insulation material has a service temperature of at least about 3000°F, preferably at least about 3300°F, and more preferably at least about 3500°F. In certain embodiments, the non-oxide based insulation material has a thermal conductivity of less than about 10 W/m·K at temperatures of 3600°F or greater. In certain embodiments, the material has a porosity greater than about 40% to enhance thermal resistance.

In certain embodiments, the non-oxide based insulation material has a thermal conductivity in a range from about 0.05 W/m·K to about 10 W/m·K, preferably from about 0.1 W/m·K to about 3 W/m·K, at temperatures of about 3600°F or greater. In certain embodiments, the thermal conductivity of the non-oxide based insulation material increases with temperature but remains below the above-noted upper limits throughout at least a temperature range of about 1800°F to about 4000°F. In certain embodiments, the non-oxide based insulation material has a thermal conductivity that is substantially less than dense graphite and substantially less than steel, thereby reducing conductive heat transfer from the fused and melted material through the mold structure.

In certain embodiments, the non-oxide based insulation material is selected to exhibit chemical stability when positioned adjacent to graphite and/or foamed carbon layers and in proximity to molten oxide materials, including but not limited to MgO, alpha alumina, beta alumina, calcia, chromia, silica, zirconia, silicon carbide, and combinations thereof. In certain embodiments, the non-oxide based insulation material resists substantial chemical attack, dissolution, or structural degradation when exposed to elevated temperatures and thermal gradients associated with casting of such fused and melted materials. While minor interfacial reactions or limited reaction layer formation may occur in certain operating environments, the non-oxide based insulation material maintains sufficient structural integrity and insulating performance to preserve reduced heat flux and extended crystal growth duration over repeated heats. In certain embodiments, the non-oxide based insulation material remains chemically stable under reducing and/or low-oxygen conditions that may be present during electro-fusion processes.

In certain embodiments, the non-oxide based insulation material is further selected to possess sufficient mechanical and thermo-mechanical stability to withstand casting operations and repeated thermal cycling. For example, the non-oxide based insulation material may exhibit resistance to compressive deformation under the load of the overlying graphite block layer and associated mold structure, resistance to cracking or spalling resulting from rapid temperature gradients during casting and cool-down, and resistance to excessive shrinkage, sintering, or densification at elevated temperatures that would otherwise increase thermal conductivity. In certain embodiments, porous or fibrous non-oxide based insulation materials accommodate differential thermal expansion between the steel box, insulation layer, foamed carbon layer, and graphite block layer while maintaining structural integrity and insulating performance over multiple heats.

Suitable non-oxide based insulation materials include, but are not limited to, carbon-based materials such as graphite foams, carbon foams, carbon aerogels, carbon felt, and carbon fiber mats; carbide-based materials such as silicon carbide (SiC) foams and porous boron carbide (B₄C); nitride-based materials such as silicon nitride (Si₃N₄), aluminum nitride (AlN), and hexagonal boron nitride (BN); and combinations thereof. These materials may be provided in monolithic, foam, porous, fibrous, or block form.

In certain embodiments, the non-oxide based insulation material functions as an outer insulating layer positioned between the steel box and a foamed carbon layer. In other embodiments, the non-oxide based insulation material may itself comprise a foamed carbon material having properties distinct from a separate foamed carbon layer positioned inwardly thereof. In still further embodiments, multiple layers of non-oxide based insulation materials may be provided.

In certain embodiments, the non-oxide based insulation material comprises a first foamed carbon layer positioned adjacent the steel box, and the foamed carbon layer formed inward thereof comprises a second foamed carbon layer positioned between the first foamed carbon layer and the graphite block layer. The first and second foamed carbon layers may be distinct structural components rather than a single homogeneous body.

In certain embodiments, the first and second foamed carbon layers may differ in density, porosity, cell structure, thermal conductivity, compressive strength, or combinations thereof. For example, the first foamed carbon layer positioned adjacent the steel box may have a lower density and lower thermal conductivity to enhance thermal resistance, while the second foamed carbon layer positioned inwardly may have a higher density or greater mechanical strength to support the overlying graphite block layer. By tailoring properties of the respective foamed carbon layers, the overall thermal resistance, interface temperature, and mechanical stability of the ingot mold may be controlled.

The use of non-oxide based insulation materials may provide improved high-temperature stability relative to oxide-based insulation materials and may reduce interface temperatures at adjacent layers while maintaining reduced heat flux and extended crystal growth time of the fused and melted material.

Without being bound by theory, it is believed that certain non-oxide based insulation materials may provide improved high-temperature stability as compared to certain oxide-based insulation materials in at least some operating conditions. For example, certain oxide-based insulation materials may exhibit softening, sintering, phase transformation, or other thermally-induced degradation at elevated temperatures and/or at interfaces adjacent higher-conductivity layers, which can increase heat flux and shorten service life. In contrast, certain non-oxide based insulation materials, including porous carbon-based, carbide-based, and nitride-based materials, may maintain insulating structure and low thermal conductivity at higher temperatures and may better tolerate thermal gradients at the interface between the steel box and the inner graphite and/or foamed carbon layers, thereby reducing the likelihood of early insulation failure and preserving the intended low heat flux over repeated heats.

In certain embodiments, selection of the non-oxide based insulation material also accounts for mechanical and thermo-mechanical considerations, including resistance to cracking, crushing, spalling, shrinkage, and thermal shock during casting and cool-down. For example, porous or fibrous non-oxide based insulation materials may accommodate differential thermal expansion between the steel box and the inner graphite and/or foamed carbon layers while maintaining insulating performance.

In certain embodiments, maintenance within the crystal growth temperature range may be confirmed by metallographic evaluation demonstrating increased average crystal size relative to material cooled in a standard practice ingot mold.

In certain embodiments incorporating a non-oxide based insulation material layer, the combined thermal resistance of the insulation layer, the foamed carbon layer, and the graphite block layer reduces heat flux through the ingot mold to less than about 25% of the heat flux of a standard practice ingot mold lined solely with dense graphite blocks, as described with respect to FIG. 3. In preferred embodiments, the relative heat flux is less than about 15%, and in more preferred embodiments less than about 10%, of the standard practice ingot mold. Such reduced heat flux may maintain the fused and melted material within a crystal growth temperature range for at least about 12 hours, preferably at least about 18 hours, and in certain embodiments between about 18 and 36 hours following casting. The reduced heat flux achieved through the incorporation of non-oxide based insulation materials may thereby enable increased crystal size, improved uniformity, and reduced casting defects relative to conventional mold constructions.

As used herein, the term “about” when used in connection with a numerical value refers to a range encompassing reasonable measurement error, modeling approximation, manufacturing tolerance, and operational variability inherent in high-temperature casting processes. Unless otherwise specified, “about” may include variations of up to ±10% of the stated value and, in certain embodiments, up to ±5% of the stated value. For percentage-based performance limitations, including relative heat flux reductions, “about” encompasses deviations attributable to differences in mold geometry, casting volume, sensor placement, environmental conditions, and calculation methodology, provided that the functional objective of reduced heat flux and extended crystal growth duration is maintained.

In the graphite and foamed carbon lined ingot mold 40 illustrated in FIG. 5, while the layer of foamed carbon 42 serves as a back-up or insulation layer of the ingot mold 40 that backs up the graphite block 44 in contact with the fused and melted material or fused cast shape, embodiments described herein are not limited thereto. For example, as previously alluded to, but not illustrated herein, the graphite block 44 can alternatively line the steel box 46 as the back-up layer, in which case the foamed carbon layer 42 can then serve as a surface layer lined on the graphite block 44 for contacting the fused and melted ingot material or fused cast shape. It is also contemplated, but not illustrated, that the foamed carbon layer 60 of the graphite, foamed carbon, and bubble alumina lined ingot mold 56 of FIG. 7 could serve as the surface layer instead of the back-up layer to the graphite block 58.

In various embodiments described herein, the respective thicknesses of the insulation layer, foamed carbon layer, and graphite block layer may be selected based upon desired heat flux reduction, ingot size, and target crystal growth duration. While certain examples above describe specific thicknesses, the invention is not limited thereto. In certain embodiments, the oxide-based or non-oxide based insulation material layer may have a thickness in a range from about 0.5 inches to about 6 inches, preferably from about 1 inch to about 4 inches. In certain embodiments, the foamed carbon layer may have a thickness in a range from about 0.5 inches to about 18 inches, preferably from about 1 inch to about 12 inches. In certain embodiments, the graphite block layer may have a thickness in a range from about 0.5 inches to about 6 inches, preferably from about 1 inch to about 4 inches.

In certain embodiments, the total combined thickness of the insulation layer and the foamed carbon layer may be greater than the thickness of the graphite block layer. In certain embodiments, the thermal resistance of the combined insulation layer and foamed carbon layer is at least twice, preferably at least three times, the thermal resistance of the graphite block layer alone. The relative thicknesses may be adjusted to maintain interface temperatures below the service temperature of the insulation material while achieving a predetermined relative heat flux reduction.

Further, even though the ingot molds described herein are ideally designed to have nearly the same distance from the center of the ingot to all sides for uniform cooling, embodiments described herein are not limited thereto. For example, the shape of the ingot mold can be a cylinder, a square, a rectangle, or any other shape that would be contemplated by one having ordinary skill in the art. Moreover, the shape of the ingot mold may not be of concern for certain materials or when striving to achieve certain goals. It is also contemplated that the foamed carbon described herein can be used with or without secondary heated furnaces or highly insulated furnace for ingot annealing.

In addition, while the examples described herein largely describe various ingot molds being used for the fusion and melting of MgO, embodiments described herein are not limited thereto. For example, the examples described herein could also be used for the fusion and melting of other oxides, such as, but not limited to, alpha alumina, beta alumina, calcia, chromia, silica, zirconia, silicon carbide, or any combination of such materials. The examples described herein could also be used the fusion and melting of other metallic materials.

It should be appreciated that the embodiments described above are described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

What is claimed:

1. An ingot mold for curing fused and melted material, comprising:
a steel box;
an insulation material layer lining an inner surface of the steel box, the insulation material layer comprising a non-oxide based insulation material having a service temperature of at least about 3000°F;
a foamed carbon layer formed inward of the insulation material layer; and
a graphite block layer formed inward of the foamed carbon layer and positioned to contact the fused and melted material,
wherein a combined thermal resistance of the insulation material layer and the foamed carbon layer is greater than a thermal resistance of the graphite block layer.

2. The ingot mold of claim 1, wherein the non-oxide based insulation material has a service temperature of at least about 3300°F.

3. The ingot mold of claim 1, wherein the non-oxide based insulation material has a service temperature of at least about 3500°F.

4. The ingot mold of claim 1, wherein the non-oxide based insulation material has a thermal conductivity less than about 10 W/m·K at temperatures of about 3600°F or greater.

5. The ingot mold of claim 1, wherein the non-oxide based insulation material has a porosity greater than about 40%.

6. The ingot mold of claim 1, wherein the non-oxide based insulation material is selected from the group consisting of carbon-based materials, carbide-based materials, nitride-based materials, and combinations thereof.

7. The ingot mold of claim 6, wherein the non-oxide based insulation material is selected from the group consisting of graphite foams, carbon foams, carbon aerogels, carbon felt, carbon fiber mats, silicon carbide foams, porous boron carbide, silicon nitride, aluminum nitride, hexagonal boron nitride, and combinations thereof.

8. The ingot mold of claim 1, wherein the insulation material layer has a thickness from about 0.5 inches to about 6 inches.

9. The ingot mold of claim 1, wherein the foamed carbon layer has a thickness from about 0.5 inches to about 18 inches.

10. The ingot mold of claim 1, wherein the graphite block layer has a thickness from about 0.5 inches to about 6 inches.

11. The ingot mold of claim 1, wherein the non-oxide based insulation material comprises a first foamed carbon layer and the foamed carbon layer formed inward thereof comprises a second foamed carbon layer.

12. The ingot mold of claim 11, wherein the first and second foamed carbon layers differ in density, porosity, or thermal conductivity.

13. The ingot mold of claim 1, further comprising:
a lid, comprising:
a steel frame;
a lid insulation material layer lining an inner surface of the steel frame;
a lid foamed carbon layer formed inward of the lid insulation material layer; and
a lid graphite block layer formed inward of the lid foamed carbon layer.

14. An ingot mold for curing fused and melted material, comprising:
a steel box;
a non-oxide based insulation material layer;
a foamed carbon layer; and
a graphite block layer positioned to contact the fused and melted material,
wherein the ingot mold reduces heat flux to less than about 25% of a heat flux of a standard practice ingot mold lined solely with dense graphite blocks.

15. The ingot mold of claim 14, wherein the ingot mold reduces heat flux to less than about 15% of the standard practice ingot mold.

16. The ingot mold of claim 14, wherein the ingot mold reduces heat flux to less than about 10% of the standard practice ingot mold.

17. The ingot mold of claim 14, wherein the fused and melted material cast into the mold remains within a crystal growth temperature range for at least about 12 hours following casting.

18. A method of producing a fused cast ingot having increased crystal size, the method comprising:
pouring fused and melted material into an ingot mold, the ingot mold including a steel box, a non-oxide based insulation material layer, a foamed carbon layer, and a graphite block layer; and
allowing the material to cool within the ingot mold,
wherein the material remains within a crystal growth temperature range for at least about 12 hours following casting.

19. The method of claim 18, wherein the material remains within the crystal growth temperature range for between about 18 hours and about 36 hours.

20. The method of claim 18, wherein the fused and melted material is selected from the group consisting of MgO, alpha alumina, beta alumina, calcia, chromia, silica, zirconia, silicon carbide, and combinations thereof.

21. An ingot mold for curing fused and melted material, comprising:
a steel box;
a non-oxide based insulation material layer lining an inner surface of the steel box;
a foamed carbon layer formed inward of the insulation material layer; and
a graphite block layer formed inward of the foamed carbon layer and positioned to contact the fused and melted material,
wherein the non-oxide based insulation material has a service temperature of at least about 3000°F,
wherein a combined thermal resistance of the insulation material layer and the foamed carbon layer is greater than a thermal resistance of the graphite block layer, and
wherein the ingot mold reduces heat flux to less than about 25% of a heat flux of a standard practice ingot mold lined solely with dense graphite blocks.

22. The ingot mold of claim 21, wherein the fused and melted material cast into the mold remains within a crystal growth temperature range for at least about 12 hours following casting.
